(19) United States
(12) Patent Application Publication
(10) Pub. No.: US 2004/0208356 A1
(43) Pub. Date: Oct. 21, 2004

(54) Method for diagnosing nondestruction deterioration and its diagnostic apparatus

(76) Inventors: Junichi Katagiri, Naka (JP); Yoshitaka Takezawa, Hitachinaka (JP); Hiroshi Shoji, Hitachi (JP); Kenichi Otaka, Hitachi (JP)

Correspondence Address: McDermott Will & Emery, 600 13th Street NW, Washington, DC, 20005-3096, US

(21) Appl. No.: 10/487,335

(22) PCT Filed: Nov. 18, 2002
(86) PCT No.: PCT/JP02/11995

(30) Foreign Application Priority Data
Nov. 20, 2001 (JP) 2001-363955
Aug. 7, 2002 (JP) 2002-229373

(51) Int. Cl. G06K 9/00

(52) U.S. Cl. 382/152

(57) ABSTRACT

A nondestructive diagnostic method and apparatus can evaluate the progress of deterioration of insulating material used in electric apparatuses in a wide-range and quantitatively.

The apparatus includes two or more kinds of different filters, an image input unit for outputting light taken in through the filters as two-dimensional image information, a light quantity measurement unit for calculating two-dimensional absorbance distribution on the basis of the two-dimensional image information, a memory unit for storing a master curve of an object to be measured, an operation unit for calculating two-dimensional absorbance difference or ratio on the basis of the master curve and the two-dimensional absorbance distribution and a display unit for making display on the basis of the calculated absorbance difference or ratio.

Thus, the simple apparatus can be used to judge the deterioration degree of the insulating material in the remote measurement manner.

### TECHNICAL FIELD

The present invention relates to a method of diagnosing deterioration without destruction and its diagnostic apparatus which can detect the progress of deterioration of insulating material used in electric apparatuses and the like.

### BACKGROUND ART

Cable laid in related facilities of an atomic power station is sometimes deteriorated earlier than other general installation environments due to deterioration factors such as heat and radiation. When the deterioration of the cable progresses or increases, the electrical insulation characteristics of the cable are reduced or deteriorated. Accordingly, it is important to diagnose the deterioration of the cable laid in such special environments particularly.

As a method of diagnosing the deterioration degree of insulating material without destruction, JP-A-10-74628 discloses a method and apparatus for illuminating an insulator of an electric apparatus such as an oil-immersed transformer and a molded transformer with two kinds of rays of monochromatic light through an optical fiber and judging the deterioration degree of the electric apparatus on the basis of the reflection power or reflectivity thereof.

### DISCLOSURE OF THE INVENTION

However, the measurement method disclosed in JP-A-10-74628 diagnoses only a small point or spot of the insulator but cannot grasp the deterioration degree of the whole insulating material and there is a problem that it takes considerable time and labor to grasp the degree of deterioration of the insulating material as a whole.

It is an object of the present invention to provide a method and apparatus for diagnosing deterioration of insulating material without destruction in the remote measurement manner by means of a simple apparatus.

Accordingly, in order to achieve the above object, a nondestructive deterioration diagnosing apparatus of the present invention comprises, for example, two or more spectroscopic means for subjecting natural light to spectroscopic processing, means for converting light to be taken in into first two-dimensional information, means for preparing second two-dimensional information on the basis of the first two-dimensional information, memory means for storing at least any of a master curve of an object to be measured and the second two-dimensional information, operation means for preparing third two-dimensional information on the basis of the master curve and the second two-dimensional information, and display means for making display on the basis of the third two-dimensional information.

Thus, according to the present invention, the deterioration of the insulating material can be diagnosed without destruction in the remote measurement manner by means of a simple apparatus.

### BRIEF DESCRIPTION OF THE DRAWINGS

FIG. 1 is a block diagram schematically illustrating an example of a nondestructive diagnostic apparatus according to the present invention;

FIG. 2 is a block diagram schematically illustrating an example of a nondestructive diagnostic apparatus according to the present invention;

FIG. 3 is a flow chart showing operation for judgment of the deterioration degree;

FIG. 4 is a graph showing an example of change in absorbance due to deterioration of insulating material; and

FIG. 5 is a graph showing an example of the relation (master curve) of difference in absorbance and deterioration.

### BEST MODE FOR CARRYING OUT THE INVENTION

The inventors have studied the relation of the deterioration and the optical properties of various insulating materials. As a result, they have elucidated that a difference or ratio in absorbance between two wavelengths is changed due to the deterioration and have discovered that the deterioration degree of the insulating material can be judged by taking a picture of or imaging the change by a CCD camera or the like and measuring the absorbance on the basis of the its image information.

The followings are considered as embodiments of the present invention, for example. However, it is a matter of course that the present invention is not limited thereto.

(1) A nondestructive deterioration diagnosing method comprises taking in an image of an object to be measured by means of an image input unit using at least two kinds of filters having the transmission sensitivity to the wavelength equal to or longer than 350 nm and equal to or shorter than 800 nm, converting digital image data into luminance (I_{A}) for each pixel by an operation unit, calculating absorbance (A_{λ}) in each wavelength by the equation (1), thereafter calculating a difference (ΔA) or ratio (A′) in the absorbance between any two wavelengths by the equation (2) or (3), comparing the deterioration degree prepared by artificially deteriorating the same material as that of the object to be measured and previously stored with the difference or ratio in the absorbance to compute the relation (master curve) of the previously stored deterioration degree and the absorbance difference or ratio, so that the deterioration degree of the object is judged to classify the distribution of the deterioration degree by color and display it two-dimensionally.

A_{λ}=−log(I_{λ}/I₀) (equation 1)

(where I₀ is reference luminance)

ΔA=A_{λ1}−A_{λ2} (equation 2)

(where λ1<λ2)

A′=A_{λ1}/A_{λ2} (equation 3)

(where λ1<λ2)

Conversion to the luminance is made in accordance with the following equation (4):

Lv=0.299R+0.587G+0.114B (equation 4)

(R, G and B are gradation values indicating brightness of red, green and blue images, respectively)

(2) A nondestructive deterioration diagnosing apparatus comprises at least two kinds of filters having the transmission sensitivity to the wavelength equal to or longer than 350 nm and equal to or shorter than 800 nm, an image input unit for taking in an image through the filters, a light quantity measurement unit for receiving light from an object to be measured and taking a picture of or imaging light intensity in each wavelength as shading image information, a memory unit for converting the image information into luminance (I_{λ}) and calculating absorbance (A_{λ}) by the equation (1) to calculate a difference (ΔA) or ratio (A′) in the absorbance between any two wavelengths by the equation (2) or (3) and previously store the relation (master curve) of the deterioration degree prepared by artificially deteriorating the same material as that of the object to be measured and the absorbance difference or absorbance ratio, an operation unit for reading in data from the memory unit and comparing the data with the measured absorbance difference or absorbance ratio to judge the deterioration degree of the object and a display unit for classifying the distribution of the deterioration degree by color and displaying it two-dimensionally.

A_{λ}=−log(I_{λ}/I₀) (equation 1)

(where I₀ is reference luminance)

ΔA=A_{λ1}−A_{λ2} (equation 2)

(where λ1<λ2)

A′=A_{λ1}/A_{λ2} (equation 3)

(where λ1<λ2)

Further, interference filters, color filters, sharp-cut filters, heat-absorbing filters, ultraviolet transmitting filters, ultraviolet transmitting and visible ray absorbing filters and dichroic filters having the transmission sensitivity to the wavelength equal to or longer than 350 nm and equal to or shorter than 800 nm are used as the filters and any two wavelengths are used. When the filter has the transmission sensitivity to the wavelength equal to or shorter than 350 nm and equal to or longer than 800 nm, it is impossible to recognize the image. Further, it is preferable that the filter has the transmission factor larger than or equal to 40% and the half-value width equal to 10 to 80 nm and it is possible to use two or more kinds of filters combined.

It is further preferable in view of accuracy of measurement that the image input format is the non-compression file format.

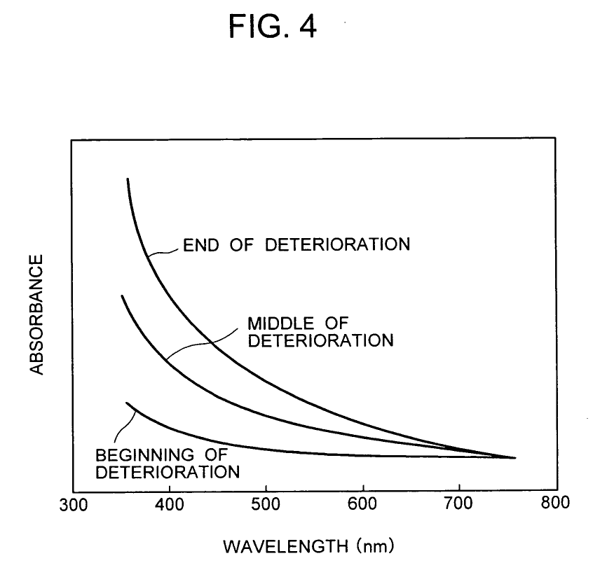

Generally, insulating material used in electric apparatuses or the like has the absorbance due to deterioration as represented as changed absorbance in FIG. 4. As shown in FIG. 4, since the absorbance on the side of the shorter wavelength is reduced due to deterioration, the insulating material for coating is getting black gradually. The increased absorbance on the side of the shorter wavelength is mainly generated by change in chemical structure (combination form) caused by deterioration due to thermal oxidation of resin and is caused by the increased loss of electron transition and absorption from the viewpoint of the physical properties. Since such behavior is exhibited, the absorbance difference or ratio between any two wavelengths is also changed due to deterioration similarly. The reason that the absorbance difference or ratio between two wavelengths is used is that influence of the surface state is canceled.

Further, as described in JP-A-3-226651, it is general that the deterioration degree is expressed by a reduced time θ. By expressing the deterioration degree by the reduced time θ, when the reduced time θ is the same, the deterioration degree is the same even for materials having various deterioration histories. The reduced time θ is defined by the following equation (5):

θ=t×exp(−ΔE/RT) (equation 5)

where ΔE represents apparent activation energy (J/mol) of deterioration, R a gas constant (J/K/mol), T an absolute temperature (K) of deterioration, and t a deterioration time (h). ΔE can be easily calculated by Arrhenius's plot by deteriorating material of the same kind artificially. Further, when the reduced time at a life point previously calculated is θ₀, a difference Δθ between the reduced time θ₀ and the reduced time θ actually measured is the reduced time corresponding to the remaining life and is a scale for judgment of the deterioration degree. That is, the remaining life Δt(h) is expressed by the following equation (6):

Δt=Δθ/exp(−ΔE/RT) (equation 6)

If the average use temperature condition after time t is decided from the equation (6), the remaining life Δt (=t₀−t) can be obtained.

The embodiment of the present invention is now described in detail by using an example.

The description of the present invention is now made with reference to the drawings, in which reference numerals used therefor are as follows: Numeral 1 denotes an object to be measured, 2 a lens, 3 a filter (1), 4 a filter (2), 5 an image input unit, 6 a light quantity measurement unit, 7 an operation unit, 8 a master-curve memory unit, and 9 a display unit.

(Embodiment 1)

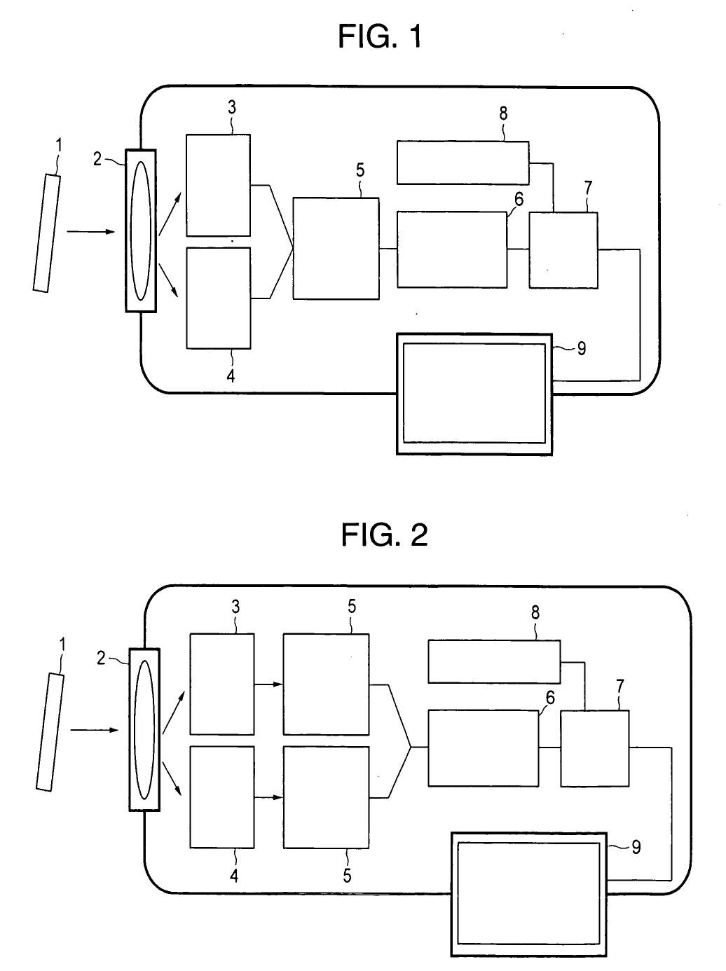

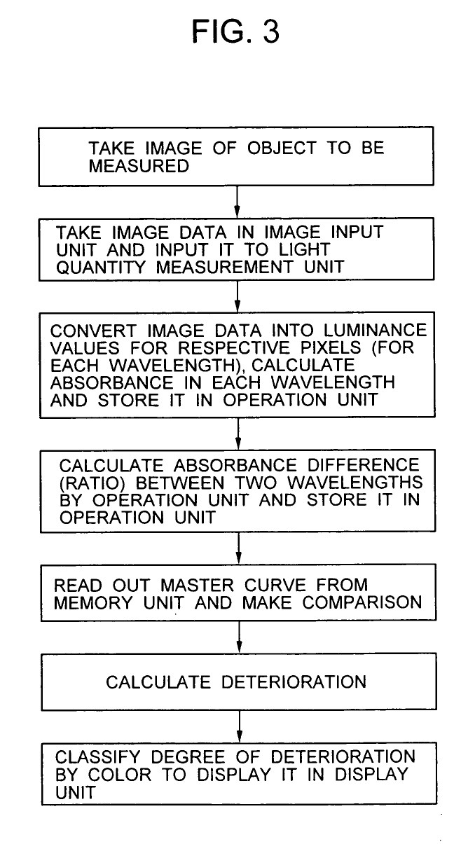

FIG. 1 is a block diagram schematically illustrating a nondestructive diagnostic apparatus of insulating material according to the embodiment and FIG. 3 is a flow chart showing operation for judgment of the deterioration degree.

The nondestructive diagnostic apparatus of FIG. 1 comprises at least a lens 2 for taking in light reflected by an object to be measured, a filter (1) 3, a filter (2) 4, an image input unit 5, a light quantity measurement unit 6, an operation unit 7 and a master-curve memory unit 8.

In the embodiment, the filter (1) 3 constituting spectroscopic means is an interference filter having the center wavelength of 430 nm, the half-value width of 60 nm and the transmission factor of 75%. Further, the filter (2) 4 is also an interference filter having the wavelength of 750 nm, the half-value width of 70 nm and the transmission factor of 85%.

The method of measuring absorbance (A₄₃₀, A₇₅₀) of the object 1 to be measured in each wavelength is now described. Two-dimensional (image) information means information grasped as spread of a plane and more particularly means information having predetermined values (luminance value, absorbance and the like) corresponding to coordinate positions in vertical and horizontal directions.

First of all, an image of the object 1 to be measured is taken in through the lens 2 from the filter (1) 3 by the image input unit 5 and is supplied as two-dimensional shading image information from the image input unit 5 to the light quantity measurement unit 6. The light quantity measurement unit 6 converts the inputted two-dimensional shading image information into luminance values for respective pixels which are the minimum unit for diagnosis of deterioration and supplies its result to the operation unit 7. The operation unit 7 calculates absorbance values for respective pixels on the basis of a previously calculated reference luminance value (I₀) and stores the calculated result as two-dimensional absorbance distribution in wavelength of 430 nm. The reference luminance value (I₀) is a value of luminance measured for each wavelength by using a copying paper (white paper) before start of measurement and preset in the operation unit 7. Further, similarly, two-dimensional image information of the object 1 to be measured is taken in by the image input unit 5 from the filter (2) 4 and inputted to the light quantity measurement unit 6 so that two-dimensional absorbance distribution in wavelength of 750 nm is stored in the operation unit 7 constituting operation means.

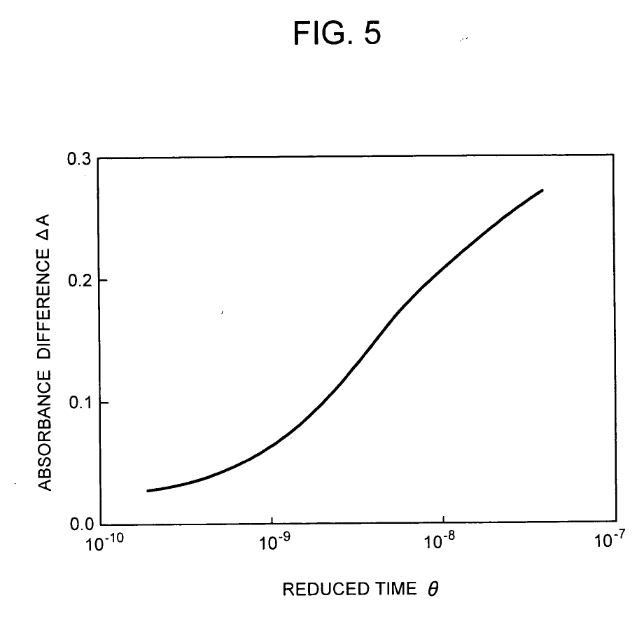

The operation unit 7 calculates absorbance difference between two wavelengths and stores its distribution for each pixel. The operation unit 7 reads out the master curve exemplified in FIG. 5 from the memory unit 5, in which the relation (master curve) of the absorbance difference prepared by artificially and acceleratedly deteriorating the material of the same kind as that of the object 1 to be measured and the deterioration degree is previously stored, and compares the master curve with the measured absorbance difference of the object for each pixel to calculate the deterioration degrees, so that the deterioration degrees are grouped or classified to change display color for each group. For example, the group having the progress of the deterioration equal to or larger than 90% is displayed in red, the group having the progress equal to 70 to 90% is displayed in yellow and the group having the progress equal to or smaller than 70% is displayed in blue so that the distribution result of the deterioration degree is displayed by the display unit 9.

As described above, the two-dimensional diagnosis using two wavelengths can be attained to thereby greatly reduce time and labor for grasping the progress of deterioration of the insulating material as a whole, whereas the conventional two-wavelength diagnosis can diagnose only the point or spot. Further, since the nondestructive diagnostic apparatus of the embodiment uses the filters having the half-value widths of 60 and 70 nm, its configuration can be made simple although some errors occur due to the half-value width. In addition, the two-dimensional nondestructive diagnosis is further useful in that it can be used for grasp and evaluation of the whole deterioration together with close or minute diagnosis of deterioration in a point or spot. Moreover, the half-value width in this case is required to be smaller than or equal to 80 nm in order to sufficiently achieve the function of roughly measuring deteriorate before close diagnosis of deterioration and required to be larger than or equal to 40 nm in order to sufficiently recognize the two-dimensional image. In this range, it is easy to prepare and obtain the spectroscopic filter and the merit of manufacturing the apparatus is sufficient. Accordingly, it is preferable that the half-value width is about 40 to 80 nm in the apparatus. Further, in order to sufficiently obtain the brightness and recognize the image, it is preferable that the transmission factor of the filter is required to have the wavelength area of 350 to 800 nm and the transmission factor therebetween is larger than or equal to 40%. When the wavelength is equal to or longer than 800 nm, the deterioration of the object to be measured cannot be recognized as the image and accordingly it is preferable that the wavelength is equal to or shorter than 800 nm.

(Embodiment 2)

The measurement is made in the same manner as the embodiment 1 with the exception that the filter (1) 3 has the transmission sensitivity to the wavelength of 400 to 480 nm, a dichroic filter having the transmission factor larger than or equal to 85% is used, the filter (2) 4 has the transmission sensitivity to the wavelength longer than or equal to 700 nm and a sharp-cut filter having the transmission factor of 90% is used.

(Embodiment 3)

The nondestructive diagnostic apparatus shown in FIG. 2 is used to thereby take in the image of the object 1 to be measured by the CCD constituting the image input apparatus as two-wavelength image data simultaneously and input the respective data to the light quantity measurement unit 6. Other conditions in the measurement are the same as the method of the embodiment 1. In the present embodiment, the CCDs constituting the image input units are provided in corresponding manner to the filters constituting a plurality of spectroscopic means to thereby make it possible to make the measurement at a time and to greatly suppress measurement errors due to measurement position and the like caused in measurement in each filter.

1. An apparatus for diagnosing deterioration without destruction, comprising:
two or more kinds of different filters;
an image input unit for outputting light taken in through said filters as two-dimensional image information;
a light quantity measurement unit for calculating two-dimensional absorbance distribution on the basis of said two-dimensional image information;
a memory unit for storing a master curve of an object to be measured;
an operation unit for calculating two-dimensional absorbance difference or ratio on the basis of said master curve and said two-dimensional absorbance distribution; and
a display unit for making display on the basis of said calculated absorbance difference or ratio.

2. A nondestructive deterioration diagnosing apparatus according to claim 1, wherein
said image input unit is separately provided in corresponding manner to each of said two or more kinds of filters.

3. A nondestructive deterioration diagnosing apparatus according to claim 1, wherein
a half-value width of said filter is equal to 10 to 80 nm.

4. A nondestructive deterioration diagnosing apparatus according to claim 1, wherein
a half-value width of said filter is larger than or equal to 10 nm.

5. A nondestructive deterioration diagnosing apparatus according to claim 1, wherein
a half-value width of said filter is smaller than or equal to 80 nm.

6. A nondestructive deterioration diagnosing apparatus according to claim 1, wherein
a transmission factor of said filter is larger than or equal to 40%.

7. A nondestructive deterioration diagnosing apparatus according to claim 1, wherein
said filter has transmission sensitivity to a wavelength longer than or equal to 350 nm and shorter than or equal to 800 nm, a transmission factor larger than or equal to 40% and a half-value width equal to 10 to 80 nm.

8. An apparatus for diagnosing deterioration without destruction, comprising:
two or more spectroscopic means for subjecting natural light to spectroscopic processing;
means for converting the light taken in through said spectroscopic means into first two-dimensional information;
means for preparing second two-dimensional information on the basis of said first two-dimensional information;
memory means for storing at least any of a master curve of an object to be measured and said second two-dimensional information;
operation means for preparing third two-dimensional information on the basis of said master curve and said second two-dimensional information; and
display means for making display on the basis of said third two-dimensional information.

9. A nondestructive deterioration diagnosing apparatus according to claim 8, wherein
said means for converting into said first two-dimensional information is provided in corresponding manner to each of said spectroscopic means.

10. A nondestructive deterioration diagnosing apparatus according to claim 8, wherein
said spectroscopic means has a half-value width shorter than or equal to 80 nm.

11. A method of diagnosing deterioration without destruction, comprising:
measuring two-dimensional image information through two or more kinds of different filters;
calculating two-dimensional absorbance distribution on the basis of said two-dimensional image information;
calculating two-dimensional absorbance difference or ratio from said calculated two-dimensional absorbance distribution;
comparing said two-dimensional absorbance difference or ratio with a previously obtained master curve; and
displaying its comparison result.

12. A nondestructive deterioration diagnosing method according to claim 11, wherein
said displaying of said comparison result comprises displaying evaluation of the progress of deterioration and its display color is changed in accordance with the progress of deterioration.

13. A nondestructive deterioration diagnosing method according to claim 11, wherein
at least any of said two-dimensional image information, said two-dimensional absorbance distribution and said two-dimensional absorbance difference or ratio is a non-compression file format.
